(19) United States
(12) Patent Application Publication
(10) Pub. No.: US 2012/0101612 A1
(43) Pub. Date: Apr. 26, 2012

(54) Personalizing New Or Already Existing Wheels To Match A Person's Particular Desire

(76) Inventor: Dennis Ray Thompson, (US)

(21) Appl. No.: 12/874,178

(22) Filed: Sep. 1, 2010

Related U.S. Application Data
(60) Provisional application No. 61/238,986, filed on Sep. 1, 2009.

(51) Int. Cl. G05B 19/4097

(52) U.S. Cl. 700/97

(57) ABSTRACT

A method for customizing off the shelf, inexpensive automobile wheel rims, or inserts for automobile wheel rims which include an art image, a name, or a logo comprises:
converting the image to a useable format for use by a vertical or horizontal machining system to machine the image into a wheel or an insert for a wheel;
enhancing and converting the image into a JPG format;
converting the JPG format image to an AutoDWG DXF file format;
importing the DXF file image into ESPRIT CADCAM software that takes the file image and converts it into a machine useable format called G-Code that makes a machine tool rotate a cutter to cut the image into the surface of the wheel or insert for a wheel; and
enhancing the image on the wheel or insert for a wheel.

### REFERENCE TO RELATED APPLICATIONS

This patent application claims the benefit of U.S. Provisional Application No. 61/238,986 filed on Sep. 1, 2009, the disclosure of which is incorporated herein by reference in its entirety.

### BACKGROUND OF THE INVENTION

1. Field of the Invention

The present invention relates to a customizing off the shelf automobile wheels or inserts for automobile wheel with a line art image, a name or a logo by first converting the image that is to be engraved into a format that can be used by a machine which utilizes the engraving tools which are used to engrave the image into the wheel or an insert for a wheel.

2. Description of Related Art

Customizing wheels is known in the prior art. More specifically, by way of example, U.S. PreGrant Publication No. 2006/0214500 to Hall; et al. discloses a system for lighting automobile wheels and rims of automobile wheels.

U.S. PreGrant Publication No. 2007/0176482 to Culiver discloses a bicycle wheel having a pair of decorative wheel discs located on each side of the bicycle wheel.

U.S. PreGrant Publication No. 2006/0129377 to Nash discloses a tire tread that has a patterns of mirror images of words or phrases where the treads imprint the road with the words or phrases.

U.S. PreGrant Publication No. 2006/0239018 to Jardin discloses a strip with multiple LEDs installed on a wheel. When the wheel rotates, the LEDs are activated to display images. The LEDs may be multi-color to display the images in colors.

U.S. PreGrant Publication No. 2005/0206219 to Johnson discloses a wheel for an automotive that has decorative features such as images of money.

U.S. PreGrant Publication No. 2004/0218398 to Fischer; et al. discloses a reflecting design pattern having at least two colors located on a tire cover.

U.S. Pat. No. 7,524,093 to Sinnette; et al. discloses a customized non-rotatable decorative image display mechanism for an automobile wheel.

U.S. Pat. No. 6,641,041 to Olds; et al. discloses an illumination system which periodically directs a short burst of bright light onto rotating indicia on an automobile wheel which makes the indicia appear to be stationary.

U.S. Pat. No. 6,093,271 to Majumdar discloses a tire having a colored sidewall. The white sidewall is partially colored with a contrasting color prior to vulcanization.

### SUMMARY OF THE INVENTION

In an exemplary embodiment of the present invention, there is disclosed a method for customizing off the shelf, inexpensive automobile wheel rims, or inserts for automobile wheel rims which include an art image, a name, or a logo comprises:

converting the image to a useable format for use by a vertical or horizontal machining system to machine the image into a wheel or an insert for a wheel;

enhancing and converting the image into a JPG format;

converting the JPG format image to an AutoDWG DXF file format;

importing the DXF file image into ESPRIT CADCAM software that takes the file image and converts it into a machine useable format called G-Code that makes a machine tool rotate a cutter to cut the image into the surface of the wheel or insert for a wheel; and

enhancing the image on the wheel or insert for a wheel.

The more important features of the invention have thus been outlined in order that the more detailed description that follows may be better understood and in order that the present contribution to the art may better be appreciated. Additional features of the invention will be described hereinafter and will form the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 is a flow diagram for personalizing automobile wheels with an art image, a name or a logo in accordance with the principles of the invention;

FIG. 2 is another embodiment of a flow diagram for personalizing inserts for automobile wheel or automobile wheels with an art image, a name or a logo in accordance with the principles of the invention; and

FIG. 3 is a perspective view of an engraved insert attached to an automobile wheel rim where the engraving can be either a personal design or a college, professional, etc., sport logo in accordance with the principles of the invention.

### DESCRIPTION OF THE PREFERRED EMBODIMENT

The present invention relates to customizing automobiles rims with an art image, a name or a logo that is provided by an automobile owner. The problem with the current customized wheels is that the wheels are mass produced and, therefore, there is a limited number of choices to choose from. But these wheels are not customized to an individual desires unless they are ordered special and are then manufactured as a set. There are companies that will make automobile wheels which are special order one of a kind wheels that are designed by an individual and which are worth tens of thousands of dollars. Most people cannot afford such an expense for their car.

The invention here disclosed can customizes off the shelf, inexpensive automobile wheel rims, or inserts for automobile wheel rims, by modifying off the shelf wheel rims to include an art image. a name, a logo, etc., which is provide by the automobile owner.

Before a machine can be used to convert an image which is provide by an automobile owner into an engraving on a wheel or a wheel rim, it is necessary that the image first be converted into a format that can be used by the machine to utilize the engraving tools which are used to engrave the image into the wheel or a wheel insert. The invention here disclosed is directed toward solving this problem.

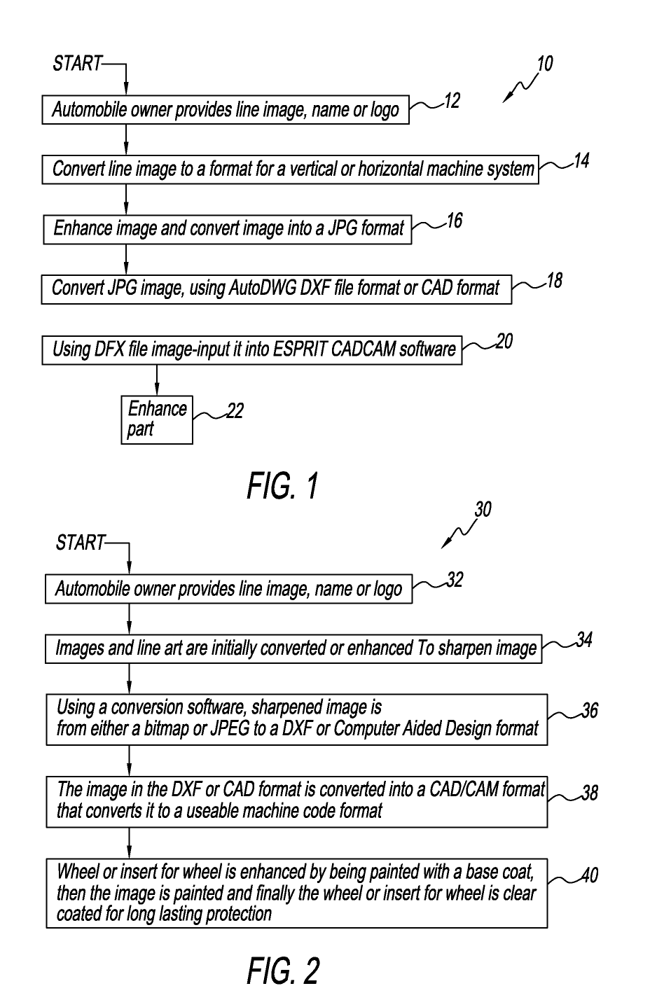

Referring to FIG. 1, there is shown a flow diagram 10 for personalizing automobile wheel rims with an art image, a name, a logo, etc., in accordance with the principles of the invention. Initially, an automobile owner provides a line image, a name, a logo, etc. that is to be placed on an automobile tire rim, block 12. The image is then converted to a useable format for a vertical or horizontal machining system to machine the image into an insert or existing wheel, block 14.

Next, the image is enhanced and converted into a JPG format, block 16. Using Windows, the images are easily converted to this format. Once in the JPG format, the Serif Draw plus X3 software is used to further enhance the image using the editing features. Once the enhanced image has been converted, the same software is used to do a trace function in black and white mode. The resulting traced image is then exported as a JPG image and is resized to a larger image. In block 18, the image is again converted using AutoDWG software. The JPG enhanced image is imported from Sarif and converted to an AutoDWG DXF file format or CAD format. The image it produces is an engraving image and is saved in a DXF file format. Now the DXF file image is import into the ESPRIT CADCAM software that takes the file image and converts it into a machine useable format called G-Code that makes the machine tool rotate a cutter and cut the image into the surface, block 20. This requires an engraving tool that is spring loaded and can be bought through an engraving supplier. The tool allows the image to be engraved onto uneven surfaces or angles or arcs into the inserts or existing wheels where the specific surfaces are of unknown or irregular shapes.

The part is now deburred, and the sharp edges are removed, block 22. In this step the insert or wheel is painted after it is first deburred and the grooves are then cleaned.

The initial process of machining on the inserts or wheels can also be accomplished by other machinery such as lasers. Plastic injection molding, stamping, and etching and engraving machinery can also be used.

Hand painting, air brushing and vinyl stickers can be used to mimic the engraving process. The images can be painted with a variety of paints including lacquers, acrylics, oil based paints, magic markers, paint pins or even dyes.

Referring to FIG. 2, there is shown another embodiment of a flow diagram 30 for personalizing automobile wheel or inserts for automobile wheels with an art image, a name or a logo in accordance with the principles of the invention. Initially, an automobile owner provides a line image, a name, a logo, etc., that is to be placed on an automobile tire rim, block 32. Next the image and line art are converted or enhanced to sharpen the image, block 34.

Working with the sharpened image and using a conversion software program that is easily obtained such as Autodwg, the image is converted from either a bitmap or JPEG to a DXF or Computer Aided Design format, block 36.

Once the image has been converted into a DXF or CAD format, the image is converted once again into a CAD/CAM format or Computer Aided Design/Computer Aided Manufacturing format that takes the CAD image and converts it to a useable machine code format that is then transferred to the machine tool that will take this conversion and machine cut the image into the wheel or insert, block 38.

The wheel or wheel insert can then go through a simple process of being painted with the base coat, then the image itself is painted, and finally the wheel or wheel insert is clear coated for long lasting protection, block 40.

In another embodiment the wheel itself can be engraved using the same process shown in FIG. 2 differing only in the process of plating or anodizing the wheel, then painting the image itself. The wheel can be clear coated if it is made of aluminum to protect the image. If the wheel is made of another type of alloy, such as chrome, brass or another material, the painting will not be protected and the automobile owner may not want the machine engraving to be painted at all.

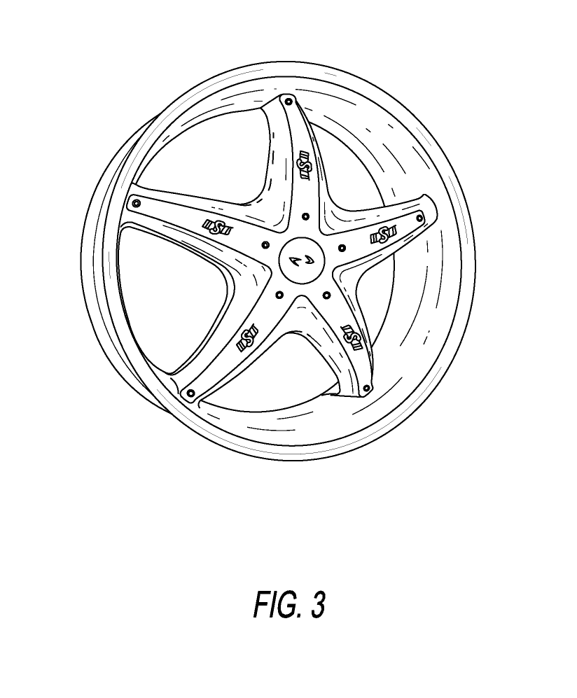

Referring to FIG. 3, there is shown a perspective view of an engraved insert attached to an automobile wheel rim where the engraving can be either a personal design or a college, professional, etc., sport logo.

The machine tool can be of various types such as vertical machining centers, horizontal machining centers, or lasers and engravers that are computerized. The conversion to a CAD/CAM format can be accomplished by a number of software companies such as ESPRIT. The Machine tools take the CAD/CAM conversion and using the software codes they machine the image into the wheel or the wheel insert.

Other processes that would add to the engraved images are plating the images with different metals such as copper or gold or brass.

Enhancements such as painting, plating, polishing or anodizing the wheel first then engraving the images will give more definition to the engraving, which will show an engraving of a different color. Wheels could be brass plated then silver plated. When engraved, the image would appear gold in color while the rest of the plated wheel would appear silver in color.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

What is claimed is:

1. A method for customizing off the shelf, inexpensive automobile wheel rims, or inserts for automobile wheel rims to include an art image, a name, or a logo comprises:
converting the image to a useable format for use by a vertical or horizontal machining system to machine the image into a wheel or an insert for a wheel;
enhancing and converting the image into a JPG format;
converting the JPG format image to an AutoDWG DXF file format;
importing the DXF file image into ESPRIT CADCAM software that takes the file image and converts it into a machine useable format called G-Code that makes a machine tool rotate a cutter to cut the image into the surface of the wheel or insert for a wheel; and
enhancing the image on the wheel or insert for a wheel.

2. The method of claim 1 wherein the step of converting the image into a JPG format image comprises using Windows.

3. The method of claim 2 wherein the JPG format is further enhanced using editing features of Serif Draw plus X3 software.

4. The method of claim 3 wherein the same software is used for performing a trace function in black and white mode on the further enhanced image.

5. The method of claim 4 wherein the traced image is resized to a larger image and exported as a JPG image.

6. The method of claim 1 wherein the step of enhancing and converting the image into aJPG format is by using Windows.

7. The method of claim 6 wherein Serif Draw plus X3 software is used to further enhance the image using the editing features.

8. The method of claim 7 wherein, using the same software, a trace function in black and white mode is used to obtain a traced image.

9. The method of claim 8 wherein the traced image is exported as a JPG image that has been resized to a larger image.

10. The method of claim 1 wherein the step of again converting the JPG format image to an AutoDWG DXF file format comprises importing the JPG enhanced image from Sarif and converting the image to an AutoDWG DXF file format.

11. The method of claim 10 wherein the image produced in the AutoDWG DXF file format is saved in a DXF file format.

12. The method of claim 1 wherein the machine useable format called G-Code that makes a machine tool rotate a cutter to cut the image into the surface of the wheel or insert for a wheel is used by an engraving tool that is spring loaded.

13. The method of claim 1 wherein the step of enhancing the image on the wheel or insert for a wheel comprises deburring and cleaning the grooves cut in the wheel or insert for a wheel and then painting the wheel or insert for a wheel.

14. The method of claim 1 wherein the image on the wheel or insert for a wheel is enhanced by painting.

15. The method of claim 14 wherein the paint includes lacquers, acrylics, oil based paints, magic markers, paint pins or dyes.

16. A method for customizing off the shelf, inexpensive automobile wheel rims, or inserts for automobile wheel rims to include an art image, a name, or a logo comprises:
enhancing and converting the image to sharpen the image;
converting the sharpened image from either a bitmap or JPEG to an image in a DFX or Compute Aided Design format using Autodwg software;
converting the image in the DFX or CAD format into a CAD/CAM format that takes the CAD image and converts it to a useable machine code format that is then transferred to a machine tool that will take the conversion and machine cut the image into a wheel or an insert for a wheel; and
enhancing the image on the wheel or insert for a wheel.

17. The method of claim 16 wherein the image on the wheel or insert for a wheel is enhanced by painting.

18. The method of claim 17 wherein the paint includes lacquers, acrylics, oil based paints, magic markers, paint pins or dyes.

19. The method of claim 16 wherein the wheel or insert for a wheel is enhanced by being painted with a base coat, then the image is painted and finally the wheel or insert for a wheel is clear coated for lasting protection.
